(19) United States
(12) Patent Application Publication
(10) Pub. No.: US 2003/0121002 A1
(43) Pub. Date: Jun. 26, 2003

(54) Method and system for exchanging information through speech via a packet-oriented network

(76) Inventors: Stuart Goose, Princeton, NJ (US); Timothy Miller, Muenchen (DE); Stefan Holz, Muenchen (DE); Wei-Kwan Vincent Su, Princeton, NJ (US)

Correspondence Address: BELL, BOYD & LLOYD, LLC, P. O. BOX 1135, CHICAGO, IL, 60690-1135, US

(21) Appl. No.: 10/037,155

(22) Filed: Dec. 20, 2001

(51) Int. Cl. G06F 15/00

(52) U.S. Cl. 715/513; 715/523

(57) ABSTRACT

A method for exchanging information through speech via a packet-oriented network having a WWW Server connected via the packet-oriented network, an information host computer which is connected to the packet-oriented network, and a speech-based browser which is connected to the information host computer. Here, a structured document which is generated with a format-based Editor is transmitted to the WWW Server and stored there with an access information item. When structured documents are accessed via the speech-based browser when the access information is present, transfer takes place to the information host computer in which an analysis of the structured document is carried out. After analysis has taken place, instructions for graphic structuring into instructions for an audible output form are modified in the structured document.

### BACKGROUND OF THE INVENTION

The present invention relates to a data-processing information system for communicating with a subscriber on the basis of natural language.

Packet-oriented networks such as, for example, the WWW (World Wide Web), and local networks (LAN), for example in the form of an “Intranet”, etc., increasingly form the main source for the exchange of information with users in a large number of application areas. For the purpose of shorter representation, such information-transmitting networks will be referred to below by the term “WWW”.

Because a growing user group relies on information available on the WWW, the need for access to this information at any time is growing. This access usually takes place using a workstation computer which is connected via data lines to one or more WWW Servers and on which a software package, known to the person skilled in the art as a “browser”, runs in order to represent the information available on the WWW Servers and to navigate within the available information. This representation is predominantly made using a visual output.

A main component of such information is data available in text format, which also contains graphics, and cross references to related information, also known to the person skilled in the art as “links”, etc. This information is usually exchanged in the form of structured documents between a WWW Server and an associated communications terminal, also referred to as a Client in the specialist field; for example, in the form of a browser. This is to be understood as meaning the organization of a definable quantity of data which, in addition to the actual information which is to be represented to the user, also contains computer-readable instructions relating to its structure. For the exchange of structured documents on the WWW, the HTML format (HyperText Markup Language) is predominantly used today.

In view of the expansion of the HTML format, numerous software packages such as, for example, Microsoft Word from the company Microsoft Corp., supply the possibility of converting formatted documents into HTML code for structured documents. Here, the HTML code which is generated by this software package can be subsequently edited by the user. Such software packages, which do not generally require any special knowledge of code conversions into HTML, are referred to below by the term “format-based Editor” for structured documents.

The necessity mentioned at the beginning of access at any time to information on the WWW increasingly also includes situations in which a person does not have a workstation computer with a visual output. For this reason, it is increasingly necessary to access the information present on the WWW in other forms of presentation; for example, in an audio format via conventional telephones.

Speech-based navigation and transmission of information on the WWW is known as an interactive speech dialog method, also referred to by the person skilled in the art as an Interactive Voice Response (IVR). The IVR method has its roots in dialog-oriented speech systems for lessening the burden of carrying out routine functions and for administering queues in call centers. For this purpose, the IVR method generally has an implementation of a speech-prompted menu in which a user has the choice between different options using speech or else by activating telephone keys.

A standard for implementing an IVR based WWW navigation is VoiceXML (Voice Extensible Markup Language), standardized by the “World Wide Web Consortium”, currently in the Version 1.0, issued on May 5, 2000 (http://www.w3.org/TR/voicexml/). This standard makes it possible to design structured documents in which information is called using speech communication. This speech communication is carried out, on the one hand, by outputting text contained in a VoiceXML script as speech to a user, and on the other hand by processing an instruction which is spoken by the user.

Calling information on a speech basis using VoiceXML requires structured documents to be drawn up and made available on a WWW Server in the VoiceXML format. As a result, a user is restricted to information which is defined in this format on a WWW Server and, in particular, he/she cannot access HTML documents. This embodiment therefore corresponds to Server-endsupport of the IVR method. In addition to the abovementioned disadvantage of the only restricted access to information, VoiceXML disadvantageously makes greater demands of the WWW Server computing power for the generation and analysis of speech. In addition, transmission capacities of the data networks which transmit the information are heavily loaded because speech information which is required and/or output into the data network for control purposes is generally transmitted as digitized audio signals, which constitutes a considerable increase in the quantity of data to be transmitted in comparison to navigating in a structured document via a mouse click or keyboard input. A further disadvantage is a higher degree of expenditure for drawing up structured documents in VoiceXML format, which process usually runs in parallel with an HTML drawing-up process.

The international patent application WO99/46920 discloses a system for navigation on the WWW with a conventional telephone. The central component of this system is a host computer system having a modem and a telephone-controlled audio WWW browser (TAWB). A subscriber dials into this system by dialing a call number assigned to the modem in a telephone network. After a successful signing-on process, the modem of the host computer system acts as an interface between the TAWB and the telephone network. The subscriber can transfer commands to the TAWB for navigation or control purposes in spoken form or else in the form of DTMF (Dual Tone MultiFrequency) signals by activating telephone keys. The TAWB interprets the commands, loads the corresponding WWW documents and converts the information contained in them into an audio format. The information is then transmitted via the telephone network to the telephone at which the subscriber can hear it. Conversion of text information into audio information is carried out by a process known to the person skilled in the art as TTS (Text to Speech).

The US patent document U.S. Pat. No. 6,018,710 discloses a method for converting structured documents into audio signals via the TTS method, particularly taking into account structural instructions contained in them.

Both methods or arrangements disclosed in the above publications operate, in contrast to the Server-end implementation by VoiceXML, with a Client-end implementation of the IVR method, and a user can therefore search for information in any structured documents without taking up large amounts of transmission capacity as mentioned above with respect to VoiceXML. However, a Client-end conversion of a structured document, which may possibly have a complex structure, into speech information has the disadvantage of confusing a user who is navigating in this document by voice as a result of the loss of the visual structuring of the document during conversion.

An object of the present invention is to specify a method which ensures that structured documents are developed on the basis of format-based Editors for structured documents without the need for expert knowledge for these structured documents to be called by a visual browser and by an IVR-based browser.

### SUMMARY OF THE INVENTION

According to the present invention, a structured document is generated with a format-based Editor; for example, Microsoft Word or Microsoft Frontpage from Microsoft Corp. In the structured document, an access information item which characterizes the document as suitable for the method according to the present invention is stored. This access information item can be stored, for example, in a data field which characterizes properties of the document. In this data field, the access information item can be, for example, in a Boolean, numerical or alphanumeric format. After the document is completed, it is transmitted to a WWW Server connected to a packet-oriented network, and stored there. If a user uses a speech-based browser, that is to say a software item configured according to the IVR method for navigating in structured documents and for displaying them, and carries out this access by, for example, specifying an address which characterizes the storage location of the structured document, according to the present invention the presence of the access information item is checked. The presence of the access information item can be characterized here as a function of a numerical or alphanumeric value stored in the structured document. If this access information item is present, the transfer to an information host computer is carried out in which the structured document is analyzed. The subject-matter of the analysis includes, in particular, instructions in the source code of the structured document. The term instructions is to be understood as computer-readable regions or character chains which bring about control of the presentation of the document and are thus not a component of the information which is contained in this document and intended for the user. These instructions are modified in a following step for presentation on a browser operating according to the IVR method in that instructions which control graphic structuring of the structured document are expanded and/or replaced by instructions which support an audible outputting form. This analysis and modification of the source code takes place at the running time; i.e., during access of a browser operating according to the IVR method to the structured document which is stored on the WWW Server.

A significant advantage of the method according to the present invention is the fact that, after the development of a document which is structured for visual browsers, it is also possible to access this document with a browser which operates according to the IVR method. This thus obviates the need for costly dual development and maintenance of structured documents in two different protocols.

The analysis and modification of the structured document stored on the WWW Server is particularly advantageous with respect to the running time, which does not require any additional preparation of storage capacity on the WWW Server.

It is also advantageous that the development of structured documents requires little knowledge of the source code which is generated automatically by the format-based Editor; for example, in an HTML format.

The information host computer advantageously has the functions of a proxy Server. A proxy Server (proxy stands for authorized agent or representative) permits indirect access to systems which do not have any direct access to the WWW. A proxy can filter out individual data packets from the data stream between the WWW and a local network and thus contribute to increasing the security. Proxy Servers are also used to limit access operations to specific Servers. The configuration of the information host computer as a proxy Server is advantageous in the method according to the present invention in that in this way labor-saving processing of the structured document is made possible. In the case of a call of the structured document by a browser operating according to the IVR method, the WWW Server is relieved of the need to process the resource-intensive analysis and modification of the source code. In the case of a call by a conventional browser based on a visual display, the structured document is directed straight to the browser, without the intermediate connection of the information host computer.

In order to generate the structured document by the format-based Editor, software libraries are used which are either integrated into the structured document or to which there are links in the structured document. This use of software libraries, which are usually present in the form of files for defining a script environment, advantageously relieves an author of structured documents of the need to process the source code of the structured document.

The use of the format-based Editor ensures a reproducible structure of the source code. The format-based Editor converts the format elements defined by the author of a structured document into instructions for a structured representation in a browser. This conversion is carried out via a defined procedure which ensures a reproducible structure of the generated source code. In the definition of cross references (for example, to other structured documents, other regions of the structured document or else to a file which is to be loaded and output and/or executed), it is advantageous to comply with conventions which permit an analysis and modification of the source code for “representation” in a browser operating according to the IVR method.

Additional features and advantages of the present invention are described in, and will be apparent from, the following Detailed Description of the Invention and the Figures.

### BRIEF DESCRIPTION OF THE FIGURES

FIG. 1 is a structural diagram schematically representing communications terminals which are connected to a packet-oriented network.

### DETAILED DESCRIPTION OF THE INVENTION

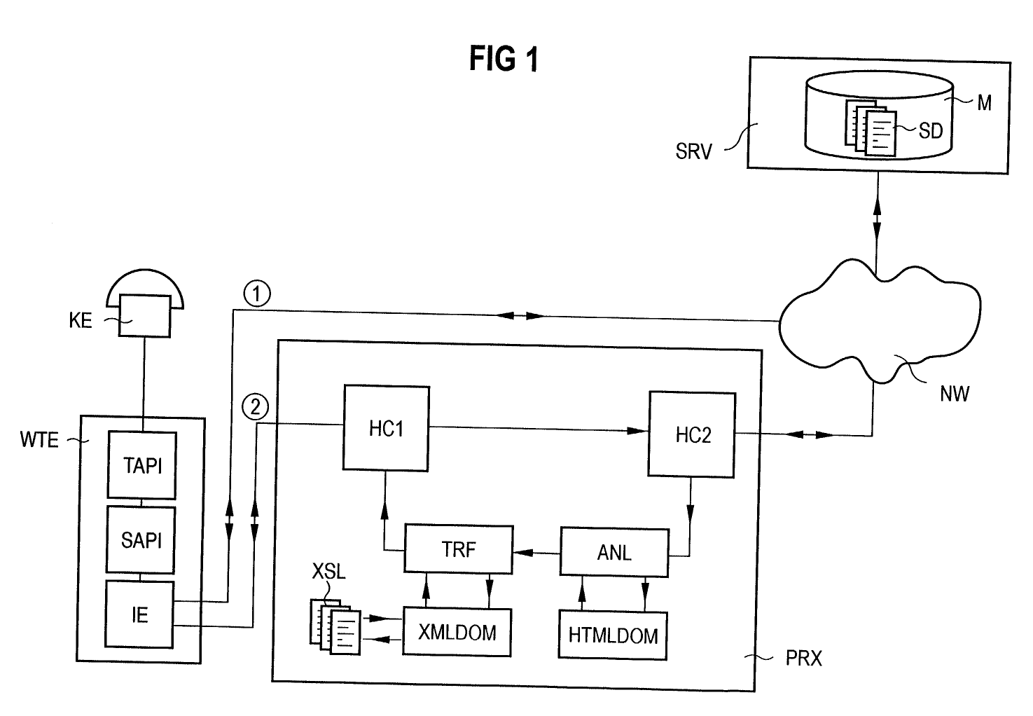

FIG. 1 illustrates a communications terminal KE which is connected to a packet-oriented network NW, for example the Internet or a local network, via a browser WTE which operates according to the IVR method (Internet Voice Response); referred to below as “IVR browser” WTE for the sake of simplification. The connection of the IVR browser WTE to the packet-oriented network NW is understood to mean, in particular, that the software of the IVR browser WTE operates on a computer system (not illustrated) which has corresponding software and hardware components for providing a data exchange with what is referred to as an Internet Service Provider (not illustrated).

An exchange of data packets (not illustrated) between the packet-oriented network NW and the browser WTE operating according to the IVR method takes place either directly (illustrated in the drawing by a numeral “1” in a circle) or with the involvement of an information host computer PRX (illustrated in the drawing by a numeral “2” in a circle).

A WWW Server (World Wide Web) SRV is connected to the packet oriented network NW and essentially has the function of administering structured documents SD stored in a memory M and transmitting them to a respective Client. As already mentioned, the packet-oriented network NW can also be configured as a local network and, in this case, the WWW Server SRV operates as an Intranet information Server.

The “connection” of, for example, the IVR browser WTE to the packet-oriented network NW (which is, in fact, without connections by its very nature) is to be understood as a source location or destination location of data packets between two communications terminals which are connected to the packet-oriented network NW. For the sake of easier illustration, the term “connection” will continue to be used. Likewise, for reasons of ease of illustration, data packets which are exchanged with the packet-oriented network NW are illustrated in the drawing using continuous lines.

The IVR browser WTE has software layers for carrying out speech-based navigation, the layers being explained below. Received data is received, processed and transferred to a speech application SAPI via a browser interface IE. This speech application SAPI processes the data in terms of speech recognition and speech synthesis. In the exemplary embodiment, an interface application “SAPI” (Speech Application Programming Interface) for 32-bit Windows operating systems from Microsoft Corp. is used for this. The data which is processed by the speech application SAPI is transferred to a telephony application TAPI which processes data received by the speech application SAPI for connection to the communications terminal KE. In the exemplary embodiment, the interface application “TAPI” (Telephony Application Programming Interface) for 32-bit Windows operating systems from Microsoft Corp. is used for this. The processing of the data, which has been described in the direction from packet-oriented data to the communications terminal KE, takes place in the other direction with correspondingly analogous functions. The control of the IVR browser by the communications terminal is carried out here via spoken keywords or by activating a telephone key (not illustrated) on the communications terminal KE. When a telephone key is activated, a DTMF (Dual Tone Multifrequency) signal is transmitted by the communications terminal KE and received and decoded by the telephony application TAPI.

The IVR browser WTE corresponds in its method of operation to, for example, the “Web Telephony Engine” from Microsoft Corp., which is described specifically at the address http://msdn.microsoft.com/library/default.asp?url=/library/en-us/htmltel/wtestartpage 61et.asp (without date information, contents referred to Nov. 8, 2001). Both commands spoken by the user and DTMF (“Dual Tone Multifrequency”) signals, which are transmitted to the IVR browser WTE and which are triggered by the user by activating a respective key on the communications terminal KE, serve for control of the IVR browser WTE by a user operating the communications terminal KE.

Before details are given on the method of operation of the information host computer PRX, properties of the structured document and conditions of the processing by the information host computer PRX will be explained.

The structured document SD is generated using a format-based Editor, for example Microsoft Word or Microsoft Frontpage from Microsoft Corp. In the structured document SD, an access information item which characterizes the structured document SD as being suitable for a transformation and transfer into the IVR browser WTE is stored. This access information item is stored, for example, in a data field which characterizes properties of the document, referred to as “document properties”. In this data field, the access information item is present, for example, in a Boolean, numerical or alphanumeric format.

After completion of the structured document SD, it is stored in the HTML format, transmitted to the WWW Server SRV and stored in its memory M.

The information host computer PRX is configured as a proxy Server which processes the contents of the structured document SD depending on the access information contained in the structured document SD. If the IVR browser WTE is used to access the structured document SD with specification of an address characterizing the storage location of the structured document, the presence of the access information is checked. If this access information is present, transfer to the information host computer PRX is brought about. If the access information is missing or does not correspond to parameters which are provided, the structured document SD is not processed by the information host computer PRX, which is illustrated in the drawing with a “1” in a circle through a direct “connection” between the IVR browser WTE and the packet-oriented network NW.

Below, reference is made to a structured document SD which is stored in the memory M of the WWW Server SRV and which has such access information. This structured document SD is loaded into the browser interface of the IVR browser WTE when there is a request by the IVR browser WTE via the processing path, illustrated by a “2” in a circle, with the involvement of the information host computer PRX.

The information host computer PRX has a first and second HTML Client HC1, HC2, which perform reception and/or transfer of the structured document SD. The first HTML Client HC1 transfers requests received at its input for structured documents to the second HTML Client HC2, which passes on these requests to the WWW Server SRV connected via the packet-oriented network NW. The corresponding structured document SD which has an access information item is subsequently transmitted by the WWW Server to the second HTML Client HC2, where it is transferred to an analysis device ANL.

The analysis device ANL carries out a syntactic analysis of the HTML source code in the structured document using functionalities of an HTML-DOM programming interface HTMLDOM (Document Object Model). For the HTML-DOM programming interface HTMLDOM, for example an object-oriented library, developed by Microsoft Corp., according to the principle of a COM (Component Object Model) interface is used, which permits an object-oriented Client/Server-based communication between a number of software applications. The use of the object-oriented HTML-DOM programming interface HTMLDOM makes possible an efficient method for the syntactic analysis of the HTML code, because the use of objects permits a structured access to the HTML code. Moreover, no read-only memory capacities are required for this analysis because the resulting objects are handled in a main memory.

The subject-matter of the analysis includes, in particular, instructions in the source code of the structured document. The term instructions is to be understood as regions or character chains which bring about control of the presentation of the document and are thus not a component of the information which is contained in this structured document SD and is to be displayed to the user.

A transformation device TRF uses the objects generated by the analysis device ANL to generate a modified, structured document SD in the XML (Extended Markup Language) format. The objects are transformed into the XML source code using functionalities of an XML-DOM programming interface XMLDOM. Here, library files XSL, for example in the form of what are referred to as “style sheets”, which permit the objects defined by the programming interface XMLDOM to be expanded, are used. For this, objects and/or methods are defined in the form of a script which is present, for example, in the form of the “extended style language”.

The use of the XML source code permits instructions of the HTML source code which control graphic structuring of the structured document SD to be expanded and/or replaced instructions which support an audible outputting form, with which the structured document can be “read” by the IVR browser WTE. This library-based processing also permits a simple transformation of the HTML source code of a structured document SD into other XML variants such as VoiceXML or WML (Wireless Markup Language).

The analysis of the HTML source code and modification into an XML source code are carried out at the running time; i.e., when the IVR browser is accessing the structured document SD stored on the WWW Server SRV.

The detailed modification in the source code of the structured document SD is explained in the patent application with the internal file number 2001P21322, for which reason only a few central procedures are explained at this point. These explanations also cover some aspects which a developer of the structured document has to comply with in a format-based Editor.

Although the present invention has been described with reference to specific embodiments, those of skill in the art will recognize that changes may be made thereto without departing from the spirit and scope of the invention as set forth in the hereafter appended claims.

1. A method for exchanging information through speech via a packet-oriented network having a WWW server which is connected via the packet-oriented network, an information host computer which is connected to the packet-oriented network, and a speech-based browser which is connected to the information host computer, the method comprising the steps of:
transmitting a structured document which is generated with a format-based editor to the WWW server;
storing the structured document in the WWW server with an access information item;
transferring the structured document to the information host computer when structured documents are accessed via the speech-based browser and the access information is present;
analyzing the structured document in the information host computer; and
modifying instructions for graphic structuring into instructions for an audible output form in the structured document.

2. A method for exchanging information through speech via a packet-oriented network as claimed in claim 1, wherein the information host computer has functions of a proxy server.

3. A method for exchanging information through speech via a packet-oriented network as claimed in claim 1, wherein the structured document is generated with an integration of at least one of software libraries and references to the software libraries.

4. A method for exchanging information through speech via a packet-oriented network as claimed in claim 1, wherein conventions defined by t he format-based editor for references to at least one of structured documents and files within a structured document are necessary when editing the structured document.

5. A method for exchanging information through speech via a packet-oriented network as claimed in claim 1, wherein the instructions in the structured document which is stored in the WWW server are in HTML format.

6. A method for exchanging information through speech via a packet-oriented network as claimed in claim 5, wherein the instructions of the structured document are converted into instructions in XML format in the information host computer.

7. A method for exchanging information through speech via a packet-oriented network as claimed in claim 6, wherein, for the conversion of the instructions from the HTML format into the XML format, an analysis device converts the instructions in the HTML format into objects using an HTML-DOM programming interface.

8. A method for exchanging information through speech via a packet-oriented network as claimed in claim 7, wherein a transformation device exchanges objects with the analysis device and converts the objects into the instructions in the XML format using an XML-DOM programming interface to a structured document based on XML instructions.

9. A method for exchanging information through speech via a packet-oriented network as claimed in claim 8, wherein library files are used in the conversion of the objects by the transformation device.

10. A system for exchanging information through speech via a packet-oriented network, comprising:
a WWW server, connected via the packet-oriented network, for at least one of calling structured documents and exchanging data;
an information host computer, connected to the packet-oriented network, for modifying instructions contained in the structured document for graphic structuring into instructions for an audible output form; and
a speech-based browser connected to the information host computer.

11. A system for exchanging information through speech via a packet oriented network as claimed in claim 10, wherein the information host computer is a proxy server.
